(19) United States
(12) Patent Application Publication
(10) Pub. No.: US 2018/0013798 A1
(43) Pub. Date: Jan. 11, 2018

(54) AUTOMATIC LINK SECURITY

(71) Applicant: Cisco Technology, Inc., San Jose, CA (US)

(72) Inventor: Derrick Pallas, San Francisco, CA (US)

(21) Appl. No.: 15/204,064

(22) Filed: Jul. 7, 2016

(51) Int. Cl. H04L 29/06; H04L 12/24; H04L 12/801; H04L 29/08; H04L 12/46

(52) U.S. Cl. CPC H04L 63/205; H04L 67/10; H04L 67/02; H04L 12/4641; H04L 47/193; H04L 41/12; H04L 63/0876

(57) ABSTRACT

Systems, methods, and computer-readable storage media for automatic link security. A cloud controller can receive a signal indicating that an unauthenticated device is requesting private network resources, establish a connection between the unauthenticated device and the cloud controller, and determine that the unauthenticated device is associated with a private network. The cloud controller can facilitate the negotiation of security material between the device and the network and automatically establish a secure link between the device and the private network. The cloud controller can cause the security material to be sent to the device and can transmit a policy instruction that is effective to cause a switch port to automatically bypass a default access policy and automatically adopt a trusted policy for device to access the private network.

### TECHNICAL FIELD

The present technology pertains to network security, and more specifically, to automatic negotiation of link security in a cloud network.

### BACKGROUND

Networks typically employ security features such as network access control to prevent unauthorized access to a network and to allow a network to provide multiple levels of access to network resources. In some cases, port-based Network Access Control (PNAC), such as IEEE 802.1x, is used to authorize devices attempting to connect to a LAN or WLAN. PNAC technology typically involves a human network administrator configuring network devices with security material (e.g. mutual authentication keys) and using an authentication server to verify the security material when a supplicant device requests access to the network. However, typical PNAC solutions that require an human administrator to program device credentials on devices and servers are burdensome, require advanced knowledge of network operations, and present opportunity for human error. Furthermore, typical PNAC security material (e.g. 802.1x certificates) is burdensome to revoke. Also, for wireless access points, an administrator needs to access the network controller to obtain configuration credentials and authenticate with the authentication server, thereby requiring the administrator to disable port security which can result in the human administrator to forget to re-enable security at the switch—which can result in a completely unsecure network access point.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a schematic block diagram of an example cloud architecture including nodes/devices interconnected by various methods of communication;

FIG. 2 illustrates a schematic block diagram of an example cloud service management system;

FIG. 3 illustrates an example method for automatically negotiating link security;

FIGS. 4A and 4B illustrate schematic block diagrams of an example cloud computing architecture including a cloud controller and a device attempting to gain access to network resources;

FIG. 5 illustrates an example method for managing link security policies for switches in an enterprise network;

FIG. 6 illustrates an example network device; and

FIGS. 7A and 7B illustrate example system embodiments.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

### Overview

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The approaches set forth herein can be used to automatically establish a secure link between network nodes. In particular, hardware and software appliances can be configured to automatically negotiate security material between a network cloud controller and a device requesting network resources. Such automatic link security can greatly increase network security, reduce human error, and alleviate the responsibilities of information technology personnel.

Disclosed are systems, methods, and computer-readable storage media for automatically establishing a secure link between a device requesting network resources and the network. A cloud controller can manage network configuration for a network. In some cases, the cloud controller can receive a signal indicating that an unauthenticated device is requesting network resources. The cloud controller can establish, or authorize the device to establish, a connection between the unauthenticated device and the cloud controller. In some cases the connection is a secure tunnel connection between an access point and the cloud controller.

The cloud controller can use the connection to receive device identification information from the unauthenticated device that is requesting access. Using that identification information, the cloud controller can determine whether or not the unauthenticated device is associated with the private network. In some cases, the identification information further defines a level of permitted access that the device has to access network resources.

After the cloud controller determines whether, and to what extent, the unauthorized device is associated with the private network, the cloud controller can facilitate the negotiation of security material between the device and the network. In some cases, the cloud controller itself negotiates the exchange of security material. In some cases, the cloud controller can cause one or more of a device controller, an access point controller, a switch controller, etc. to negotiate the security material.

The negotiated security material can be used to automatically establish a secure link between the device and the private network. In some cases, the cloud controller can cause the security material to be sent to the device and the device can use the security material to authenticate itself and satisfy a default port-based network access control (PNAC) policy that limits network access to unknown access points. In some cases, the cloud controller can transmit a policy instruction to a switch port or switch port controller, where the policy instruction is effective to cause the switch port to automatically bypass a default PNAC policy and automatically adopt a trusted policy for device to access the private network. In some cases, the trusted policy further causes the switch port to revert to the default PNAC policy when the automatically-authenticated device is removed from the switch port.

### Description

A computer network can include a system of hardware, software, protocols, and transmission components that collectively allow separate devices to communicate, share data, and access resources, such as software applications. More specifically, a computer network is a geographically distributed collection of nodes interconnected by communication links and segments for transporting data between endpoints, such as personal computers and workstations. Many types of networks are available, ranging from local area networks (LANs) and wide area networks (WANs) to overlay and software-defined networks, such as virtual extensible local area networks (VXLANs), and virtual networks such as virtual LANs (VLANs) and virtual private networks (VPNs).

LANs typically connect nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links. LANs and WANs can include layer 2 (L2) and/or layer 3 (L3) networks and devices.

The Internet is an example of a public WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol can refer to a set of rules defining how the nodes interact with each other. Computer networks may be further interconnected by intermediate network nodes, such as routers, switches, hubs, or access points (Aps), which can effectively extend the size or footprint of the network.

Networks can be segmented into subnetworks to provide a hierarchical, multilevel routing structure. For example, a network can be segmented into subnetworks using subnet addressing to create network segments. This way, a network can allocate various groups of IP addresses to specific network segments and divide the network into multiple logical networks.

In addition, networks can be divided into logical segments called virtual networks, such as VLANs, which connect logical segments. For example, one or more LANs can be logically segmented to form a VLAN. A VLAN allows a group of machines to communicate as if they were in the same physical network, regardless of their actual physical location. Thus, machines located on different physical LANs can communicate as if they were located on the same physical LAN. Interconnections between networks and devices can also be created using routers and tunnels, such as VPN or secure shell (SSH) tunnels. Tunnels can encrypt point-to-point logical connections across an intermediate network, such as a public network like the Internet. This allows secure communications between the logical connections and across the intermediate network. By interconnecting networks, the number and geographic scope of machines interconnected, as well as the amount of data, resources, and services available to users can be increased.

Further, networks can be extended through network virtualization. Network virtualization allows hardware and software resources to be combined in a virtual network. For example, network virtualization can allow multiple numbers of VMs to be attached to the physical network via respective VLANs. The VMs can be grouped according to their respective VLAN, and can communicate with other VMs as well as other devices on the internal or external network.

To illustrate, overlay networks generally allow virtual networks to be created and layered over a physical network infrastructure. Overlay network protocols, such as Virtual Extensible LAN (VXLAN), Network Virtualization using Generic Routing Encapsulation (NVGRE), Network Virtualization Overlays (NVO3), and Stateless Transport Tunneling (STT), provide a traffic encapsulation scheme which allows network traffic to be carried across L2 and L3 networks over a logical tunnel. Such logical tunnels can be originated and terminated through virtual tunnel end points (VTEPs).

Moreover, overlay networks can include virtual segments, such as VXLAN segments in a VXLAN overlay network, which can include virtual L2 and/or L3 overlay networks over which VMs communicate. The virtual segments can be identified through a virtual network identifier (VNI), such as a VXLAN network identifier, which can specifically identify an associated virtual segment or domain.

Networks can include various hardware or software appliances or nodes to support data communications, security, and provision services. For example, networks can include routers, hubs, switches, APs, firewalls, repeaters, intrusion detectors, servers, VMs, load balancers, application delivery controllers (ADCs), and other hardware or software appliances. Such appliances can be distributed or deployed over one or more physical, overlay, or logical networks. Moreover, appliances can be deployed as clusters, which can be formed using layer 2 (L2) and layer 3 (L3) technologies. Clusters can provide high availability, redundancy, and load balancing for flows associated with specific appliances or nodes. A flow can include packets that have the same source and destination information. Thus, packets originating from device A to service node B can all be part of the same flow.

Endpoint groups (EPGs) can also be used in a network for mapping applications to the network. In particular, EPGs can use a grouping of application endpoints in a network to apply connectivity and policy to the group of applications. EPGs can act as a container for groups or collections of applications, or application components, and tiers for implementing forwarding and policy logic. EPGs also allow separation of network policy, security, and forwarding from addressing by instead using logical application boundaries.

Appliances or nodes, as well as clusters, can be implemented in cloud deployments. Cloud deployments can be provided in one or more networks to provision computing services using shared resources. Cloud computing can generally include Internet-based computing in which computing resources are dynamically provisioned and allocated to client or user computers or other devices on-demand, from a collection of resources available via the network (e.g., “the cloud”). Cloud computing resources, for example, can include any type of resource, such as computing, storage, network devices, applications, virtual machines (VMs), services, and so forth. For instance, resources may include service devices (firewalls, deep packet inspectors, traffic monitors, load balancers, etc.), compute/processing devices (servers, CPU's, memory, brute force processing capability), storage devices (e.g., network attached storages, storage area network devices), etc. In addition, such resources may be used to support virtual networks, virtual machines (VM), databases, applications (Apps), etc. Also, services may include various types of services, such as monitoring services, management services, communication services, data services, bandwidth services, routing services, configuration services, wireless services, architecture services, etc.

The cloud may include a “private cloud,” a “public cloud,” and/or a “hybrid cloud.” A “hybrid cloud” can be a cloud infrastructure composed of two or more clouds that inter-operate or federate through technology. In essence, a hybrid cloud is an interaction between private and public clouds where a private cloud joins a public cloud and utilizes public cloud resources in a secure and scalable manner. In some cases, the cloud can be include one or more cloud controllers which can help manage and interconnect various elements in the cloud as well as tenants or clients connected to the cloud.

Cloud controllers and/or other cloud devices can be configured for cloud management. These devices can be pre-configured (i.e, come “out of the box”) with centralized management, layer 7 (L7) device and application visibility, real time web-based diagnostics, monitoring, reporting, management, and so forth. As such, in some embodiments, the cloud can provide centralized management, visibility, monitoring, diagnostics, reporting, configuration (e.g., wireless, network, device, or protocol configuration), traffic distribution or redistribution, backup, disaster recovery, control, and any other service. In some cases, this can be done without the cost and complexity of specific appliances or overlay management software.

Networks typically employ security features such as network access control to prevent unauthorized access to a network and to allow a network to provide multiple levels of access to network resources. In some cases, port-based Network Access Control (PNAC), such as IEEE 802.1x, is used to authorize devices attempting to connect to a LAN or WLAN. PNAC technology typically involves a network administrator configuring network devices with security material (e.g. mutual authentication keys) and using an authentication server to verify the security material when a supplicant device requests access to the network. However, typical PNAC solutions that require an administrator to program device credentials on a device and server are burdensome, require advanced knowledge of network operations, presents opportunity for human error. Furthermore, typical PNAC security material (e.g. 802.1x certificates) is burdensome to revoke. Also, for wireless access points, an administrator needs to access the network controller to obtain configuration credentials and authenticate with the authentication server, thereby requiring the administrator to disable port security which can result in the human administrator to forget to re-enable security at the switch—which can result in a completely unsecure network access point.

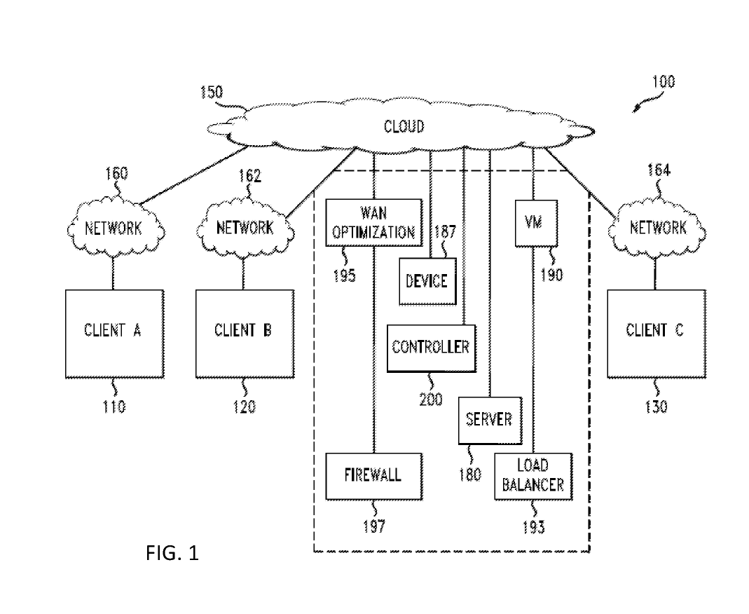

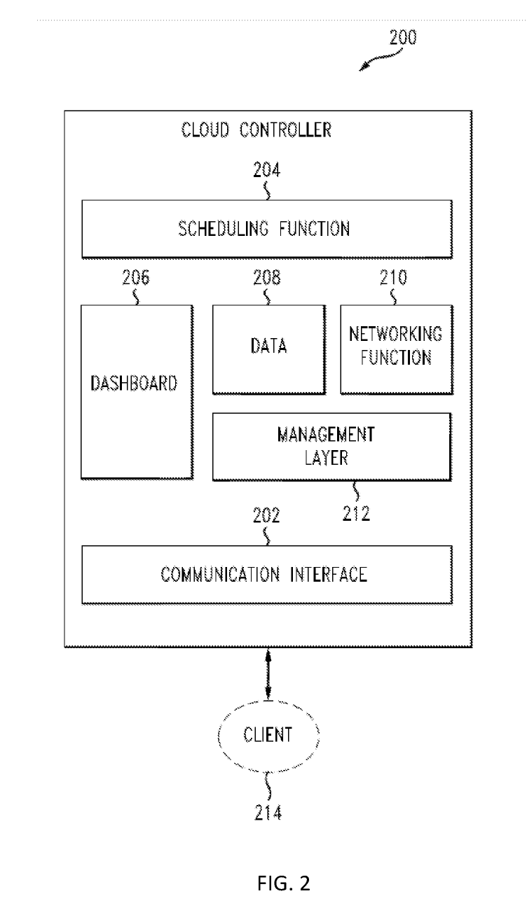

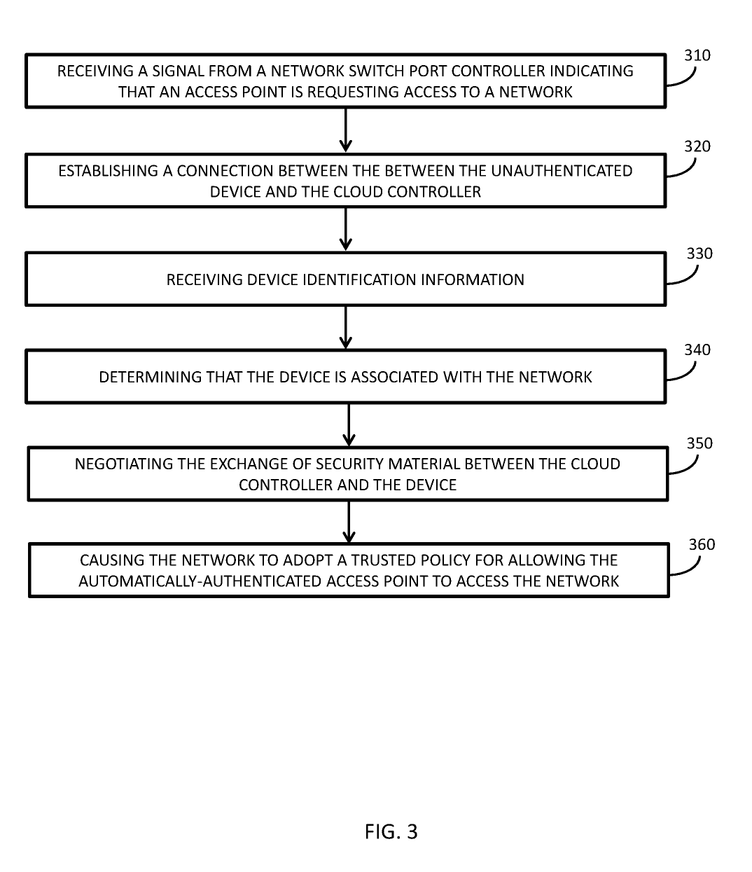

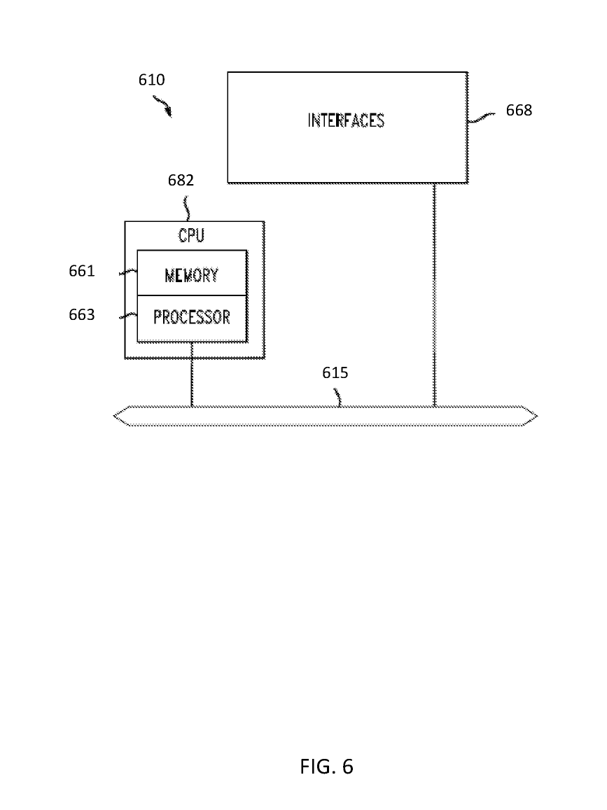

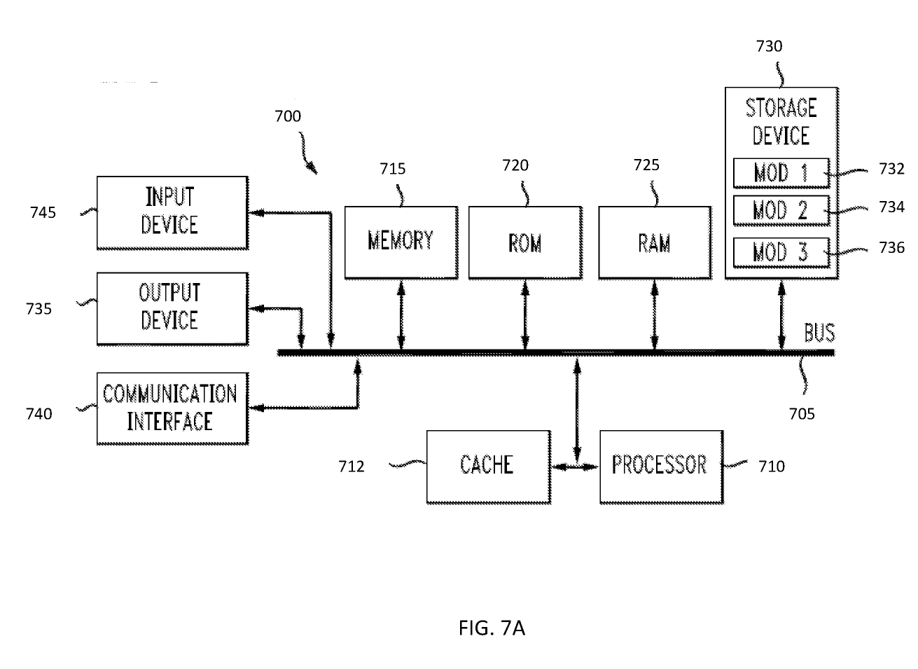

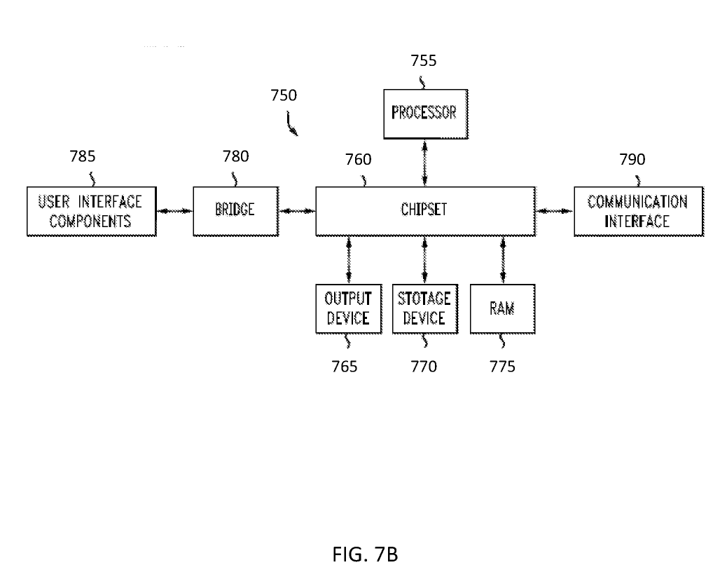

The disclosed technology addresses the need in the art for improved network security. Disclosed are systems, methods, and computer-readable storage media for automatic link security and improved switch port security that uses automatic link security and that avoids the need to enable, disable, and re-enable switch port security. A description of cloud computing environments, as illustrated in FIGS. 1 and 2, is first disclosed herein. A discussion of automatic link security and, including examples and variations, as illustrated in FIGS. 3-5, will then follow. The discussion then concludes with a brief description of example devices, as illustrated in FIGS. 6 and 7A-B. These variations shall be described herein as the various embodiments are set forth. The disclosure now turns to FIG. 1.

FIG. 1 illustrates a schematic block diagram of an example cloud architecture 100 including nodes/devices interconnected by various methods of communication. Cloud 150 can be a public, private, and/or hybrid cloud system. Cloud 150 can include resources, such as one or more Firewalls 197; Load Balancers 193; WAN optimization platforms 195; devices 187, such as switches, routers, intrusion detection systems, Auto VPN systems, or any hardware or software network device; servers 180, such as dynamic host configuration protocol (DHCP), domain naming system (DNS), or storage servers; virtual machines (VMs) 190; controllers 200, such as a cloud controller or a management device; or any other resource.

Cloud resources can be physical, software, virtual, or any combination thereof. For example, a cloud resource can include a server running one or more VMs or storing one or more databases. Moreover, cloud resources can be provisioned based on requests (e.g., client or tenant requests), schedules, triggers, events, signals, messages, alerts, agreements, necessity, or any other factor. For example, the cloud 150 can provision application services, storage services, management services, monitoring services, configuration services, administration services, backup services, disaster recovery services, bandwidth or performance services, intrusion detection services, VPN services, or any type of services to any device, server, network, client, or tenant.

In addition, cloud 150 can handle traffic and/or provision services. For example, cloud 150 can provide configuration services, such as auto VPN, automated deployments, automated wireless configurations, automated policy implementations, and so forth. In some cases, the cloud 150 can collect data about a client or network and generate configuration settings for specific service, device, or networking deployments. For example, the cloud 150 can generate security policies, subnetting and routing schemes, forwarding schemes, NAT settings, VPN settings, and/or any other type of configurations. The cloud 150 can then push or transmit the necessary data and settings to specific devices or components to manage a specific implementation or deployment. For example, the cloud 150 can generate VPN settings, such as IP mappings, port number, and security information, and send the VPN settings to specific, relevant device(s) or component(s) identified by the cloud 150 or otherwise designated. The relevant device(s) or component(s) can then use the VPN settings to establish a VPN tunnel according to the settings.

To further illustrate, cloud 150 can provide specific services for client A (110), client B (120), and client C (130). For example, cloud 150 can deploy a network or specific network components, configure links or devices, automate services or functions, or provide any other services for client A (110), client B (120), and client C (130). Other non-limiting example services by cloud 150 can include network administration services, network monitoring services, content filtering services, application control, WAN optimization, firewall services, gateway services, storage services, protocol configuration services, wireless deployment services, and so forth.

To this end, client A (110), client B (120), and client C (130) can connect with cloud 150 through networks 160, 162, and 164, respectively. More specifically, client A (110), client B (120), and client C (130) can each connect with cloud 150 through networks 160, 162, and 164, respectively, in order to access resources from cloud 150, communicate with cloud 150, or receive any services from cloud 150. Networks 160, 162, and 164 can each refer to a public network, such as the Internet; a private network, such as a LAN; a combination of networks; or any other network, such as a VPN or an overlay network.

Moreover, client A (110), client B (120), and client C (130) can each include one or more networks. For example, (110), client B (120), and client C (130) can each include one or more LANs and VLANs. In some cases, a client can represent one branch network, such as a LAN, or multiple branch networks, such as multiple remote networks. For example, client A (110) can represent a single LAN network or branch, or multiple branches or networks, such as a branch building or office network in Los Angeles and another branch building or office network in New York. If a client includes multiple branches or networks, the multiple branches or networks can each have a designated connection to the cloud 150. For example, each branch or network can maintain a tunnel to the cloud 150. Alternatively, all branches or networks for a specific client can connect to the cloud 150 via one or more specific branches or networks. For example, traffic for the different branches or networks of a client can be routed through one or more specific branches or networks. Further, client A (110), client B (120), and client C (130) can each include one or more routers, switches, appliances, client devices, VMs, or any other devices. In some cases, client A (110), client B (120), and/or client C (130) can also maintain links between branches. For example, client A can have two branches, and the branches can maintain a link between each other.

In some cases, branches can maintain a tunnel between each other, such as a VPN tunnel. Moreover, the link or tunnel between branches can be generated and/or maintained by the cloud 150. For example, the cloud 150 can collect network and address settings for each branch and use those settings to establish a tunnel between branches. In some cases, the branches can use a respective tunnel between the respective branch and the cloud 150 to establish the tunnel between branches. For example, branch 1 can communicate with cloud 150 through a tunnel between branch 1 and cloud 150 to obtain the settings for establishing a tunnel between branch 1 and branch 2. Branch 2 can similarly communicate with cloud 150 through a tunnel between branch 2 and cloud 150 to obtain the settings for the tunnel between branch 1 and branch 2.

In some cases, cloud 150 can maintain information about each client network, in order to provide or support specific services for each client, such automatic link security as further described below in FIGS. 3-5. Cloud 150 can also maintain one or more links or tunnels to client A (110), client B (120), and client C (130). For example, cloud 150 can maintain a VPN tunnel to one or more devices in client A's network. In some cases, cloud 150 can configure the VPN tunnel for a client, maintain the VPN tunnel, or automatically update or establish any link or tunnel to the client or any devices of the client.

The cloud 150 can also monitor device and network health and status information for client A (110), client B (120), and client C (130). To this end, client A (110), client B (120), and client C (130) can synchronize information with cloud 150. Cloud 150 can also manage and deploy services for client A (110), client B (120), and client C (130). For example, cloud 150 can collect network information about client A and generate network and device settings to automatically deploy a service for client A. In addition, cloud 150 can update device, network, and service settings for client A (110), client B (120), and client C (130). For example, cloud 150 can negotiate automatic link security for a connection with client A, as further described below.

Those skilled in the art will understand that the cloud architecture 150 can include any number of nodes, devices, links, networks, or components. In fact, embodiments with different numbers and/or types of clients, networks, nodes, cloud components, servers, software components, devices, virtual or physical resources, configurations, topologies, services, appliances, deployments, or network devices are also contemplated herein. Further, cloud 150 can include any number or type of resources, which can be accessed and utilized by clients or tenants. The illustration and examples provided herein are for clarity and simplicity.

Moreover, as far as communications within the cloud architecture 100, packets (e.g., traffic and/or messages) can be exchanged among the various nodes and networks in the cloud architecture 100 using specific network communication protocols. In particular, packets can be exchanged using wired protocols, wireless protocols, or any other protocols. Some non-limiting examples of protocols can include protocols from the Internet Protocol Suite, such as TCP/IP; OSI (Open Systems Interconnection) protocols, such as L1-L7 protocols; routing protocols, such as RIP, IGP, BGP, STP, ARP, OSPF, EIGRP, NAT; or any other protocols or standards, such as HTTP, SSH, SSL, RTP, FTP, SMTP, POP, PPP, NNTP, IMAP, Telnet, SSL, SFTP, WIFI, Bluetooth, VTP, ISL, IEEE 802 standards, L2TP, IPSec, etc. In addition, various hardware and software components or devices can be implemented to facilitate communications both within a network and between networks. For example, switches, hubs, routers, access points (APs), antennas, network interface cards (NICs), modules, cables, firewalls, servers, repeaters, sensors, etc.

FIG. 2 illustrates a schematic block diagram of an example cloud controller 200. The cloud controller 200 can serve as a cloud service management system for the cloud 150. In particular, the cloud controller 200 can manage cloud operations, client communications, service provisioning, network configuration and monitoring, etc. For example, the cloud controller 200 can manage cloud service provisioning, such as cloud storage, media, streaming, security, or administration services. In some embodiments, the cloud controller 200 can manage negotiating an exchange of security material between a network and connecting devices as further described in FIG. 3, below.

For example, the cloud controller 200 can receive access requests from an access point connected to the network through a switch port via a secure tunnel, determine that the access point is trusted, and negotiate security material with the access point without requiring manual configuration, and instruct the switch port to adopt a trusted PNAC policy for the trusted access point.

The cloud controller 200 can include several subcomponents, such as a scheduling function 204, a dashboard 206, data 208, a networking function 210, a management layer 212, and a communications interface 202. The various subcomponents can be implemented as hardware and/or software components. Moreover, although FIG. 2 illustrates one example configuration of the various components of the cloud controller 200, those of skill in the art will understand that the components can be configured in a number of different ways and can include any other type and number of components. For example, the networking function 210 and management layer 212 can belong to one software module or multiple separate modules. Other modules can be combined or further divided up into more subcomponents.

The scheduling function 204 can manage scheduling of procedures, events, or communications. For example, the scheduling function 204 can schedule when resources should be allocated from the cloud 150. As another example, the scheduling function 204 can schedule when specific instructions or commands should be transmitted to the client 214. In some cases, the scheduling function 204 can provide scheduling for operations performed or executed by the various subcomponents of the cloud controller 200. The scheduling function 204 can also schedule resource slots, virtual machines, bandwidth, device activity, status changes, nodes, updates, etc.

The dashboard 206 can provide a frontend where clients can access or consume cloud services. For example, the dashboard 206 can provide a web-based frontend where clients can configure client devices or networks that are cloud-managed, provide client preferences, specify policies, enter data, upload statistics, configure interactions or operations, etc. In some cases, the dashboard 206 can provide visibility information, such as views of client networks or devices. For example, the dashboard 206 can provide a view of the status or conditions of the client's network, the operations taking place, services, performance, a topology or layout, specific network devices, protocols implemented, running processes, errors, notifications, alerts, network structure, ongoing communications, data analysis, etc.

Indeed, the dashboard 206 can provide a graphical user interface (GUI) for the client 214 to monitor the client network, the devices, statistics, errors, notifications, etc., and even make modifications or setting changes through the GUI. The GUI can depict charts, lists, tables, maps, topologies, symbols, structures, or any graphical object or element. In addition, the GUI can use color, font, shapes, or any other characteristics to depict scores, alerts, or conditions. In some cases, the dashboard 206 can also handle user or client requests. For example, the client 214 can enter a service request through the dashboard 206.

The data 208 can include any data or information, such as management data, statistics, settings, preferences, profile data, logs, notifications, attributes, configuration parameters, client information, network information, and so forth. For example, the cloud controller 200 can collect network statistics from the client 214 and store the statistics as part of the data 208. In some cases, the data 208 can include performance and/or configuration information. This way, the cloud controller 200 can use the data 208 to perform management or service operations for the client 214. The data 208 can be stored on a storage or memory device on the cloud controller 200, a separate storage device connected to the cloud controller 200, or a remote storage device in communication with the cloud controller 200.

The networking function 210 can perform networking calculations, such as network addressing, or networking service or operations, such as auto VPN configuration or traffic routing. For example, the networking function 210 can perform filtering functions, switching functions, automatic link security functions, network or device deployment functions, resource allocation functions, messaging functions, traffic analysis functions, port configuration functions, mapping functions, packet manipulation functions, path calculation functions, loop detection, cost calculation, error detection, or otherwise manipulate data or networking devices. In some embodiments, the networking function 210 can handle networking requests from other networks or devices and establish links between devices. In other embodiments, the networking function 210 can perform queuing, messaging, or protocol operations.

The management layer 212 can include logic to perform management operations. For example, the management layer 212 can include the logic to allow the various components of the cloud controller 200 to interface and work together. The management layer 212 can also include the logic, functions, software, and procedure to allow the cloud controller 200 perform monitoring, management, control, and administration operations of other devices, the cloud 150, the client 214, applications in the cloud 150, services provided to the client 214, or any other component or procedure. The management layer 212 can include the logic to operate the cloud controller 200 and perform particular services configured on the cloud controller 200.

Moreover, the management layer 212 can initiate, enable, or launch other instances in the cloud controller 200 and/or the cloud 150. In some embodiments, the management layer 212 can also provide authentication and security services for the cloud 150, the client 214, the controller 214, and/or any other device or component. Further, the management layer 212 can manage nodes, resources, VMs, settings, policies, protocols, communications, etc. In some embodiments, the management layer 212 and the networking function 210 can be part of the same module. However, in other embodiments, the management layer 212 and networking function 210 can be separate layers and/or modules. The communications interface 202 allows the cloud controller 200 to communicate with the client 214, as well as any other device or network. The communications interface 202 can be a network interface card (NIC), and can include wired and/or wireless capabilities. The communications interface 202 allows the cloud controller 200 to send and receive data from other devices and networks. In some embodiments, the cloud controller 200 can automatically negotiate of link security for nodes in a cloud network, as described in more detail below.

As explained above, typical network security techniques are burdensome, require advanced network know-how, and otherwise inadequate. The disclosed technology involves systems, methods, and computer-readable storage media for automatic link security and improved switch port security that uses automatic link security and that avoids the need to enable, disable, and re-enable switch port security. In some cases, the cloud controller 200 can automatically negotiate security material for an unknown device for automatically authenticating the device with a network.

FIG. 3 illustrates an example method 300 for automatically negotiating link security. The method involves a cloud controller receiving a signal indicating that an unauthenticated device is requesting access to a network 310. In some cases, the cloud controller can receive the signal indicating that an unauthenticated device is requesting access to the network from a switch controller for a switch port associated with the network when the unauthenticated device is coupled with the switch port. In some cases the switch controller can be separate from the cloud controller. Also, the switch controller can be part of the cloud controller.

After receiving the signal indicating that the unauthenticated device is requesting access to the network, the method 300 can involve the cloud controller establishing a connection between the unauthenticated device and the cloud controller 320. In some cases, establishing a connection between the unauthenticated device and the cloud controller involves receiving a request from an unauthenticated device to establish a tunnel (e.g., VPN tunnel, etc.) between the unauthenticated device and the cloud controller and establishing the tunnel. Also, in some cases the request from the unauthenticated device to establish the tunnel between the unauthenticated device and the cloud controller is received through a device controller that is separate from the cloud controller.

After the device is connected with the cloud controller, the method 300 can involve receiving, through the connection, device identification information 330. For example, the device identification information can involve a link-level identifier, e.g. MAC. Next, the method 300 can involve the cloud controller determining that the device is associated with the network 340. In some cases, the cloud controller can determine that the device is associated with the network using the device identification information by examining whether the devices are all part of the same locale. For example, controllers can be known to each other through some external means such as the controllers being virtually and explicitly connected. Also, controllers can implicitly discover each other through the access point advertising the access point controller (e.g. via LLDP) and the switch using that information to inform its controller to contact the AP controller.

Also, when an enterprise on-boards a new enterprise device or a batch of enterprise devices (e.g. network printers, employee phones, wireless access points to distribute to new locations associated with the enterprise, etc.) the device identification information for the new enterprise devices can be associated with the enterprise's private network.

Also, in some cases, the identification information further defines a level of permitted access that the device has to access network resources and the cloud controller can determine various permissions, levels of access, etc. for the device.

After the device is determined to be associated with the network, the method 300 can involve the cloud controller negotiating the exchange of security material between the cloud controller and the device 350 where the security material can be used for automatically authenticating the device and establishing a secure link between the device and the network. The method 300 can involve causing the network to adopt a trusted policy for allowing the automatically-authenticated access point to access the network 360 without the need for a network operator to configure the device.

In some cases, causing the network to adopt a trusted policy for allowing the automatically-authenticated access point to access the network involves the cloud controller sending the security material to the device through the tunnel for allowing the device to authenticate itself according to a default port-based network access control (PNAC) policy. In some cases, causing the network to adopt a trusted policy for allowing the automatically-authenticated access point to access the network involves the cloud controller sending a switch controller a policy instruction which causes the switch port to automatically bypass a default (PNAC) policy and automatically adopt a trusted policy for allowing the automatically-authenticated device to access the network.

Also, in some cases, the adopted trust policy can involve causing a switch port to revert to the default PNAC policy when the automatically-authenticated device is removed from the switch port.

In some cases, the network comprises a private network with access to a public network resources and private network resources and the switch port has a default port-based network access control (PNAC) policy that grants unauthenticated devices access to the public network resources, but throttles access to the private resources. According to the disclosed technology, trusted policy can further cause the network to grant the automatically-authenticated device access to both the public network resources and access to the private network resources.

In some cases, a switch port can enforce (e.g. by itself, through a switch controllers, etc.) a default PNAC policy that prevents an unauthorized device from accessing any network access. However, the switch port can also be configured to recognize (e.g. by reading an EEPROM in the device) that a particular unknown device can directly establish an independently secure tunnel to the cloud controller. In these cases, after the cloud controller receives the signal indicating that the unauthenticated device is requesting access to the network, the cloud controller can send a bypass instruction to the switch port. The bypass instruction can cause the switch port to bypass the default PNAC policy and allow the device to establish a connection between the access point and the cloud controller.

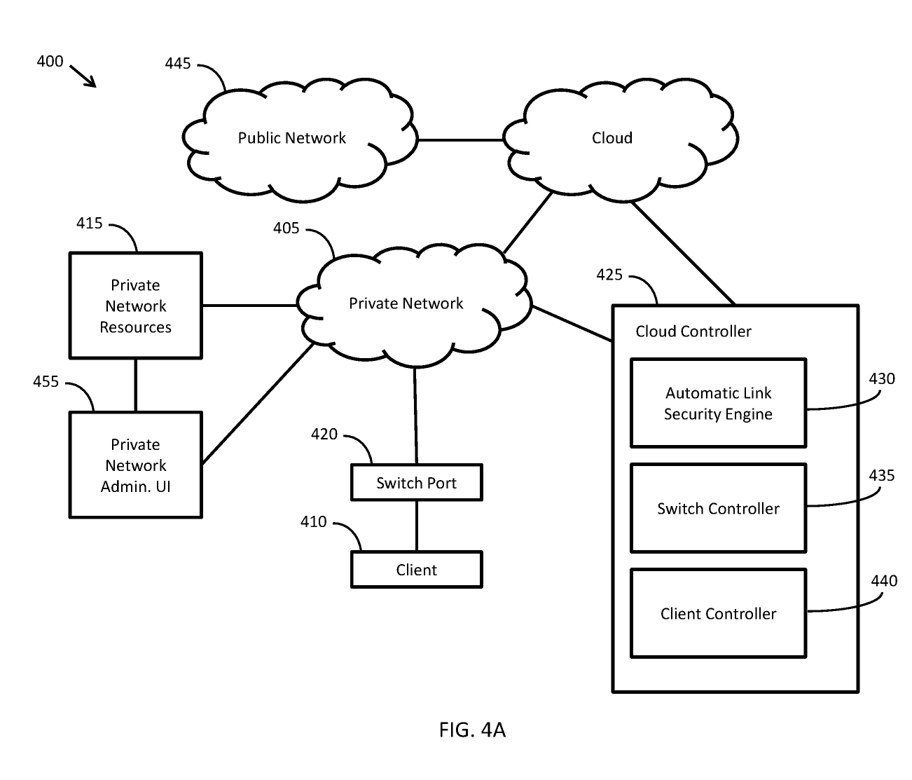

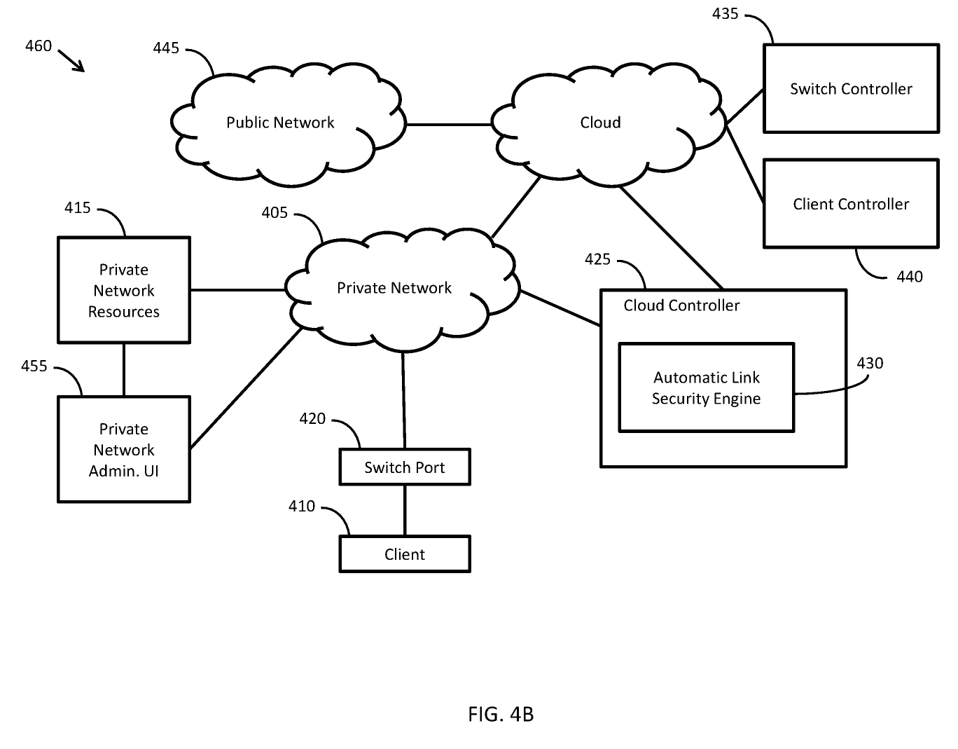

FIG. 4A illustrates a schematic block diagram of an example cloud computing architecture 400 including a cloud controller and a device attempting to gain access to network resources. The cloud computing architecture 400 can include a public, private, and/or hybrid cloud system. The cloud computing architecture 400 can include a wide variety of resources (not shown) and can handle a wide variety of services—as briefly summarized in FIG. 1.

Referring again to FIG. 4A, cloud computing architecture 400 can provide specific services for client 410. For example, client 410 can be an unknown access point (AP) attempting to gain access to a private network 405 and private network resources 415 through a switch port 420. Cloud computing architecture 400 can include a cloud controller 425 that can serve as a cloud service management system for the cloud computing architecture 400 and that can provide services such as those summarized in FIG. 2. The cloud controller 425 shown in FIG. 4A can also include an automatic link security engine 430 for providing specific link security services to network components. In some cases, the cloud controller 425 includes one or more specific sub-controllers for automatic negotiating link security for specific network components. For example, the cloud controller 425 can include a switch controller 435 and client controller 440.

The cloud controller 425 can provide specific automatic link security negotiation services when the client 410 requests access to the private network 405. In some cases, when the client 410 connects with the switch port 420 (e.g. through a LAN/WLAN connection), the private network can enforce a default port-based network access control (PNAC) policy that limits network access to unknown client devices. For example, the default PNAC policy can allow the unknown client 410 to access resources from a public network 450 (e.g. the Internet) through the private network 405 and can initially restrict the unknown client device 410 from accessing the private resources 415. The default PNAC policy can also allow the unknown client device 410 to establish a connection with the cloud controller 425—as indicated by link 450.

When the client 410 establishes a connection with cloud controller 425, cloud controller 425 can receive the signal indicating that an unauthenticated device is requesting access to the private network 405 through the switch port 420. Through the connection with the client 410, the cloud controller 425 can retrieve client identification data for the client 410. For example, the cloud controller can retrieve a Universal Device Identifier (UDID), a Media Access Control (MAC) address, etc. from the client 410. The cloud controller 425 can also determine that the client 410 is associated with the private network 405 using the client identification data. For example, the cloud controller 425 can access a database (not shown) containing client identification data for client devices associated with the private network 405 to determine that the client 410 is associated with the private network 405. For example, the database can be located within the cloud controller, stored in the private network resources, or located remotely and accessible by the cloud controller 425. Also, the private network 405 can include a private network administrator user interface platform 455 that allows an administrator to specify client devices that are associated with a private network. For example, when deploying a batch of wireless access points for an enterprise, an administrator for the enterprise can associate client identification data for each device in the batch with the private network.

The cloud controller 425 can also, after determining that the client 410 is associated with the private network, automatically provide a secure link between the private network 405 and the client 410 by negotiating the exchange of security material. The cloud controller 425 can include an automatic link security engine 430 that can cause the switch controller 435 and a client controller 440 to exchange security material (e.g. passwords, 802.1x credentials, etc.) and the switch controller 435 and the client controller 440. In some cases, the cloud controller 425 and/or the client controller 440 can send the security material to the client 410 and the client 410 can access the private network 405 and private network resources 415 according to the switch port's 420 default PNAC policy. Also, in some cases, the switch controller 435 and/or the cloud controller 425 can send the switch port 420 an instruction that causes the switch port 420 to bypass the default PNAC policy to a trusted policy for allowing the client device 410 to access the private network 405 and private network resources 415. The automatic link security engine 430 can also specify a trusted policy that causes the switch port 420 to revert to the default PNAC policy when the client 410 is removed from the switch port 420.

FIG. 4B illustrates a schematic block diagram of an example cloud computing architecture 460 including a cloud controller 425 and a client 410 attempting to gain access to private network resources 415. In FIG. 4B, the cloud computing architecture 460 is similar to FIG. 4A and includes a cloud controller 425 with an automatic link security engine 430 for negotiating security material for a client 410 attempting to access the private network resources 415 of a private network 405 through a switch port 420. However, in FIG. 4B, the switch controller 435 and the client controller 440 are separate from the cloud controller 425. In these cases, after the cloud controller 425 determines that a client device 410 is associated with the private network 405, the automatic link security engine 430 in the cloud controller 425 can cause the switch controller 435 and the client controller 440 to negotiate security material. The client controller 440 can independently send the client the negotiated security material and the switch controller 435 can independently send the switch port an instruction to accept the client's 410 security material and/or an instruction to change its default PNAC policy to a trusted policy for the client 410.

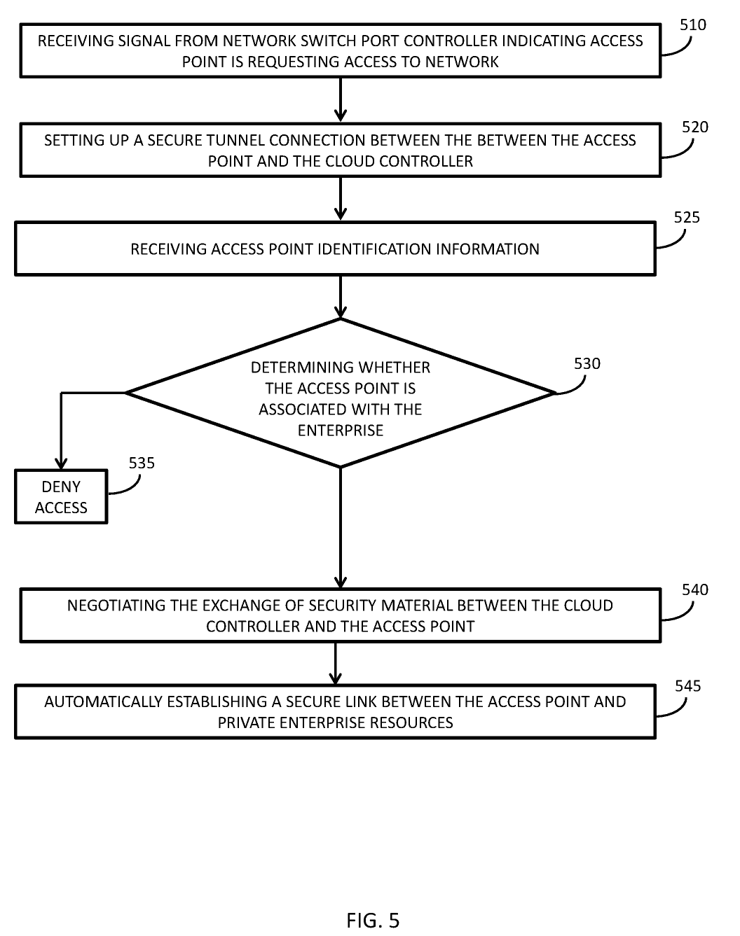

FIG. 5 illustrates an example method 500 for managing link security policies for switches in an enterprise network. An enterprise network can be set up with a default port-based Network Access Control (PNAC) policy for allowing access to public network resources (i.e. the Internet) and private enterprise resources. In the private enterprise network, a cloud controller can receive inputs from nodes in the network when the nodes request access to network resources. For example, a switch port controller can send a signal to the cloud controller when an access point requests access to private network resources upon being connected to the network through a switch port.

The method 500 involves a cloud controller receiving a signal from a network switch port controller indicating that an access point is requesting access to a network 510 when the access point is plugged in to the switch port associated with the network switch point controller. After receiving the signal indicating that the unauthenticated device is requesting access to the network, the method 500 can involve the cloud controller setting up a secure tunnel connection between the between the access point and the cloud controller 520.

After the access point is connected with the cloud controller through the secure tunnel, the method 500 can involve receiving access point identification information 525 and the cloud controller determining whether the access point is associated with the enterprise 530. When the cloud controller determines that the access point is not associated with the network, the method 500 involves denying the access point automatic link security and access to private network resources 535. Depending on the default PNAC policy, the access point can sometime still access public network resources, but the access point would require manual configuration of security material, e.g. onboarding access point using traditional 802.1x configuration to access private enterprise network resources.

When the cloud controller determines that the access point is associated with the enterprise, the method 500 can involve the cloud controller negotiating the exchange of security material between the cloud controller and the access point 540 and automatically establishing a secure link between the access point and private enterprise resources 545. For example, providing automatic link security can involve sending an instruction to the switch controller (or directly to the switch) that is effective to cause the switch to bypass its default PNAC policy and enable a trusted policy for the access point to allow the access point to access the private enterprise resources and to revert to the default PNAC policy when the access point is removed from the switch port.

While the various examples above are described in terms of specific devices, such as appliances or branches, one of ordinary skill in the art will readily recognize that the concepts described herein can apply to other devices, networks, or environments.

FIG. 6 illustrates an example network device 610 suitable for implementing automatic link security. Network device 610 includes a master central processing unit (CPU) 662, interfaces 668, and a bus 615 (e.g., a PCI bus). When acting under the control of appropriate software or firmware, the CPU 662 is responsible for executing packet management, error detection, and/or routing functions. The CPU 662 preferably accomplishes all these functions under the control of software including an operating system and any appropriate applications software. CPU 662 may include one or more processors 663 such as a processor from the Motorola family of microprocessors or the MIPS family of microprocessors. In an alternative embodiment, processor 663 is specially designed hardware for controlling the operations of router 610. In a specific embodiment, a memory 661 (such as non-volatile RAM and/or ROM) also forms part of CPU 662. However, there are many different ways in which memory could be coupled to the system.

The interfaces 668 are typically provided as interface cards (sometimes referred to as “line cards”). Generally, they control the sending and receiving of data packets over the network and sometimes support other peripherals used with the router 610. Among the interfaces that may be provided are Ethernet interfaces, frame relay interfaces, cable interfaces, DSL interfaces, token ring interfaces, and the like. In addition, various very high-speed interfaces may be provided such as fast token ring interfaces, wireless interfaces, Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management. By providing separate processors for the communications intensive tasks, these interfaces allow the master microprocessor 662 to efficiently perform routing computations, network diagnostics, security functions, etc.

Although the system shown in FIG. 6 is one specific network device of the present invention, it is by no means the only network device architecture on which the present invention can be implemented. For example, an architecture having a single processor that handles communications as well as routing computations, etc. is often used. Further, other types of interfaces and media could also be used with the router.

Regardless of the network device's configuration, it may employ one or more memories or memory modules (including memory 661) configured to store program instructions for the general-purpose network operations and mechanisms for roaming, route optimization and routing functions described herein. The program instructions may control the operation of an operating system and/or one or more applications, for example. The memory or memories may also be configured to store tables such as mobility binding, registration, and association tables, etc.

FIG. 7A and FIG. 7B illustrate example system embodiments. The more appropriate embodiment will be apparent to those of ordinary skill in the art when practicing the present technology. Persons of ordinary skill in the art will also readily appreciate that other system embodiments are possible.

FIG. 7A illustrates a conventional system bus computing system architecture 700 wherein the components of the system are in electrical communication with each other using a bus 705. Exemplary system 700 includes a processing unit (CPU or processor) 710 and a system bus 705 that couples various system components including the system memory 715, such as read only memory (ROM) 770 and random access memory (RAM) 775, to the processor 710. The system 700 can include a cache of high-speed memory connected directly with, in close proximity to, or integrated as part of the processor 710. The system 700 can copy data from the memory 715 and/or the storage device 730 to the cache 717 for quick access by the processor 710. In this way, the cache can provide a performance boost that avoids processor 710 delays while waiting for data. These and other modules can control or be configured to control the processor 710 to perform various actions. Other system memory 715 may be available for use as well. The memory 715 can include multiple different types of memory with different performance characteristics. The processor 710 can include any general purpose processor and a hardware module or software module, such as module 1 737, module 7 734, and module 3 736 stored in storage device 730, configured to control the processor 710 as well as a special-purpose processor where software instructions are incorporated into the actual processor design. The processor 710 may essentially be a completely self-contained computing system, containing multiple cores or processors, a bus, memory controller, cache, etc. A multi-core processor may be symmetric or asymmetric.

To enable user interaction with the computing device 700, an input device 745 can represent any number of input mechanisms, such as a microphone for speech, a touch-sensitive screen for gesture or graphical input, keyboard, mouse, motion input, speech and so forth. An output device 735 can also be one or more of a number of output mechanisms known to those of skill in the art. In some instances, multimodal systems can enable a user to provide multiple types of input to communicate with the computing device 700. The communications interface 740 can generally govern and manage the user input and system output. There is no restriction on operating on any particular hardware arrangement and therefore the basic features here may easily be substituted for improved hardware or firmware arrangements as they are developed.

Storage device 730 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 775, read only memory (ROM) 770, and hybrids thereof.

The storage device 730 can include software modules 737, 734, 736 for controlling the processor 710. Other hardware or software modules are contemplated. The storage device 730 can be connected to the system bus 705. In one aspect, a hardware module that performs a particular function can include the software component stored in a computer-readable medium in connection with the necessary hardware components, such as the processor 710, bus 705, display 735, and so forth, to carry out the function.

FIG. 7B illustrates an example computer system 750 having a chipset architecture that can be used in executing the described method and generating and displaying a graphical user interface (GUI). Computer system 750 is an example of computer hardware, software, and firmware that can be used to implement the disclosed technology. System 750 can include a processor 755, representative of any number of physically and/or logically distinct resources capable of executing software, firmware, and hardware configured to perform identified computations. Processor 755 can communicate with a chipset 760 that can control input to and output from processor 755. In this example, chipset 760 outputs information to output 765, such as a display, and can read and write information to storage device 770, which can include magnetic media, and solid state media, for example. Chipset 760 can also read data from and write data to RAM 775. A bridge 780 for interfacing with a variety of user interface components 785 can be provided for interfacing with chipset 760. Such user interface components 785 can include a keyboard, a microphone, touch detection and processing circuitry, a pointing device, such as a mouse, and so on. In general, inputs to system 750 can come from any of a variety of sources, machine generated and/or human generated.

Chipset 760 can also interface with one or more communication interfaces 790 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 755 analyzing data stored in storage 770 or 775. Further, the machine can receive inputs from a user via user interface components 785 and execute appropriate functions, such as browsing functions by interpreting these inputs using processor 755.

It can be appreciated that example systems 700 and 750 can have more than one processor 710 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. Moreover, claim language reciting “at least one of” a set indicates that one member of the set or multiple members of the set satisfy the claim.

What is claimed is:

1. A computer-implemented method comprising:
receiving, in a controller associated with a network, a signal indicating that an unauthenticated device is requesting access to the network;
establishing a connection between the unauthenticated device and the controller;
receiving, through the connection, device identification information;
determining, by the cloud controller using the device identification information, that the device is associated with the network;
negotiating, by the controller, security material for automatically authenticating the device with the network; and
causing the network to adopt a trusted policy for allowing the automatically-authenticated device to access the network.

2. The computer-implemented method of claim 1, wherein the signal indicating that an unauthenticated device is requesting access to the network is received from a switch controller for a switch port associated with the network after the unauthenticated device is coupled with the switch port.

3. The computer-implemented method of claim 2, wherein the controller comprises a cloud controller and the switch controller is part of the cloud controller.

4. The computer-implemented method of claim 2, further comprising;
after receiving the signal indicating that the unauthenticated device is requesting access to the network, sending a bypass instruction to the switch port, wherein the bypass instruction is effective for causing the switch port to bypass a default port-based network access control (PNAC) policy that limits network access to unknown devices and that allows unknown devices to establish a connection between the device and the controller.

5. The computer-implemented method of claim 2, wherein causing the network to adopt the trusted policy further comprises sending the security material to the device through a tunnel, wherein the security material is used by the device to authenticate the device according to a default port-based network access control (PNAC) policy.

6. The computer-implemented method of claim 2, wherein causing the network to adopt the trusted policy further comprises sending, to the switch port controller, a policy instruction that is effective to cause the switch port to automatically bypass a default port-based network access control (PNAC) policy and automatically adopt a trusted policy for automatically-authenticated device to access the network.

7. The computer-implemented method of claim 2, wherein the trusted policy further causes the switch port to revert to the default port-based network access control (PNAC) policy when the automatically-authenticated device is removed from the switch port.

8. The computer-implemented method of claim 2, wherein the network comprises a private network with access to public network resources and private network resources, wherein the switch port has a default port-based network access control (PNAC) policy that involves granting the unauthenticated device access to the public network resources, and wherein the trusted policy involves granting the automatically-authenticated device access to the public network resources and access to the private network resources.

9. The computer-implemented method of claim 2, wherein establishing a connection between the unauthenticated device and the controller comprises:
receiving a request from the unauthenticated device to establish a tunnel between the unauthenticated device and the controller; and
establishing the tunnel between the unauthenticated device and the controller.

10. The computer-implemented method of claim 9, wherein the request from the unauthenticated device to establish the tunnel between the unauthenticated device and the controller is received through an device controller that is separate from the controller.

11. A cloud controller on a network, the cloud controller comprising:
a processor; and
a computer-readable storage medium having stored therein instructions which, when executed by the processor, cause the processor to perform operations comprising:
receiving a signal indicating that an unauthenticated access point is requesting access to the network;
establishing a connection between the between the unauthenticated access point and the cloud controller;
receiving, through the connection, access point identification information;
determining, using the access point identification information, that the access point is associated with the network;
negotiating security material for automatically authenticating the access point with the network; and
causing the network to adopt a trusted policy for allowing the automatically-authenticated access point to access the network.

12. The cloud controller of claim 11, wherein the signal indicating that an unauthenticated access point is requesting access to the network is received from a switch controller for a switch port associated with the network after the unauthenticated access point is coupled with the switch port.

13. The cloud controller of claim 12, wherein the switch controller is part of the cloud controller.

14. The cloud controller of claim 12, wherein causing the network to adopt the trusted policy further comprises sending the security material to the access point through the tunnel, wherein the security material is used by the access point to authenticate the access point according to a default port-based network access control (PNAC) policy.

15. The cloud controller of claim 12, wherein causing the network to adopt the trusted policy further comprises sending, to the switch port controller, a policy instruction that is effective to cause the switch port to automatically bypass a default port-based network access control (PNAC) policy and automatically adopt a trusted policy for automatically-authenticated access point to access the network.

16. The cloud controller of claim 12, wherein the trusted policy further causes the switch port to revert to the default port-based network access control (PNAC) policy when the automatically-authenticated access point is removed from the switch port.

17. A non-transitory computer-readable storage medium having stored therein instructions which, when executed by a processor in a cloud controller associated with a network, cause the processor to perform operations comprising:
receiving a signal from a switch port controller associated with a switch port in the network, the signal indicating that an unauthenticated access point is requesting access to the network through the switch port;
establishing a secure tunnel connection between the between the unauthenticated access point and the cloud controller;
receiving, through the secure tunnel connection, access point identification information;
determining, using the access point identification information, that the unauthenticated access point is associated with the network;
negotiating security material for automatically authenticating the access point with the network; and
sending, to the switch controller, a policy instruction that is effective to cause the switch port to automatically bypass a default port-based network access control (PNAC) policy and automatically adopt a trusted policy for the access point to access the network and to revert to the default PNAC policy when the access point is removed from the switch port.

18. The non-transitory computer-readable storage medium of claim 17, wherein causing the automatically-authenticated access point and the network to adopt the trusted policy further comprises sending the security material to the access point through the tunnel, wherein the security material is used by the access point to authenticate the access point according to a default port-based network access control (PNAC) policy.

19. The non-transitory computer-readable storage medium of claim 17, wherein causing the automatically-authenticated access point and the network to adopt the trusted policy further comprises sending, to the switch port controller, a policy instruction that is effective to cause the switch port to automatically bypass a default port-based network access control (PNAC) policy and automatically adopt a trusted policy for automatically-authenticated access point to access the network.

20. The non-transitory computer-readable storage medium of claim 17, wherein the trusted policy further causes the switch port to revert to the default port-based network access control (PNAC) policy when the automatically-authenticated access point is removed from the switch port.
